(19) United States
(12) Patent Application Publication
(10) Pub. No.: US 2008/0226981 A1
(43) Pub. Date: Sep. 18, 2008

(54) CENTER PIN CYLINDRICAL SECONDARY BATTERY AND CYLINDRICAL SECONDARY BATTERY HAVING THE SAME

(75) Inventor: Ji-Hyoung YOON, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/948,035

(22) Filed: Nov. 30, 2007

(30) Foreign Application Priority Data
Mar. 16, 2007 (KR) 2007-26203

(51) Int. Cl. H01M 2/08; H01M 2/00

(52) U.S. Cl. 429/174; 429/122

(57) ABSTRACT

A center pin of a cylindrical secondary battery and a cylindrical secondary battery including the same are provided. The cylindrical secondary battery includes: an electrode assembly including a positive electrode plate, a negative electrode plate and a separator disposed between the two plates; a cylindrical center pin disposed at a center of the electrode assembly and having a polygonal hole formed in a longitudinal direction at a center of the center pin; a can containing the electrode assembly and the center pin; and a cap assembly sealing the can, wherein each corner of the polygonal hole of the center pin has a curvature. Providing a curvature in each corner of the cylindrical center pin reinforces the strength of the center pin and minimizes the deformation of the electrode assembly during charge/discharge operation.

### CROSS-REFERENCE TO RELATED APPLICATION

This application claims the benefit of Korean Application No. 2007-26203, filed Mar. 16, 2007, the disclosure of which is hereby incorporated herein by reference.

### BACKGROUND OF THE INVENTION

1. Field of the Invention

Aspects of the present invention relate to a center pin for a cylindrical secondary battery. More particularly, aspects of the present invention relate to a center pin that minimizes the deformation of the electrode assembly during charge/discharge operations. The center pin has a hole formed in a longitudinal direction at the center that is polygonally shaped to provide reinforcement. The center pin is disposed at the center of an electrode assembly that is wound in a cylinder shape. Aspects of the present invention further relate to a cylindrical secondary battery having the center pin.

2. Description of the Related Art

Recently, compact and lightweight portable electronic/electrical appliances such as cellular phones, notebook computers and camcorders have been actively developed and produced. These portable electronic/electrical appliances have a secondary battery such that they can be operated in any place even without a separate power supply. Generally, the secondary battery is a chargeable and dischargeable battery such as, for example, a nickel-cadmium (Ni—Cd) battery, a nickel-hydrogen (Ni-MH) battery or a lithium (Li) battery.

The Li secondary battery is widely applied to portable appliances because it has an operating voltage that is three times higher than other batteries (Ni—Cd and Ni-MH batteries), and a high energy density per unit weight. Li secondary batteries are classified into Li ion batteries using an aqueous electrolyte and Li polymer batteries using a polymer electrolyte based on the electrolyte, and are also classified into cylindrical, prismatic and pouch batteries based on the shape.

The cylindrical secondary battery commonly includes an electrode assembly that is wound in cylindrical shape, a center pin disposed at the center of the electrode assembly, a can containing the electrode assembly, center pin and an electrolyte that enables a lithium ion to travel between electrodes of the electrode assembly, and a cap assembly sealing the can. The electrode assembly includes a positive electrode plate including a positive electrode collector on which a positive active material is applied and a positive electrode tap electrically connected to one side of the positive electrode collector; a negative electrode plate including a negative electrode collector on which a negative active material is applied and a negative electrode tap electrically connected to one side of the negative electrode collector; and a separator disposed between the two electrode plates. The center pin is disposed at the center of the electrode assembly so as to prevent the deformation of the electrode assembly during charge/discharge operations of the electrode assembly, and has a hole formed therein in a longitudinal direction so as to provide a path for transporting a gas generated around the electrode assembly due to an internal disorder to the cap assembly.

A method for disposing the center pin at the center of the electrode assembly includes inserting the electrode assembly that is wound in cylinder shape into the can, and then inserting the cylindrical center pin having a polygonal hole formed therein in a longitudinal direction into a space formed at the center of the electrode assembly. Alternatively, the center pin may be disposed at the center of the electrode assembly by rotating the center pin after fixing one end of the electrode assembly to one side of the center pin, and then winding the electrode assembly around the center pin.

According to the latter method, the hole formed in a longitudinal direction inside the center pin may have a polygonal shape rather than a circular shape, in order to apply a rotatory power to the center pin. However, the thickness of the center pin is smaller in a region at which a corner of the polygonal hole is located than it is at other regions, so that the overall strength of the center pin is weakened, and the deformation of the electrode assembly may not be sufficiently prevented during charge/discharge operations of the cylindrical secondary battery.

### SUMMARY OF THE INVENTION

Aspects of the present invention relates to a center pin for a cylindrical secondary battery. More particularly, aspects of the present invention relate to a center pin that minimizes the deformation of the electrode assembly during charge/discharge operations. The center pin has a hole formed in a longitudinal direction at the center that is polygonally shaped to provide reinforcement. The center pin is disposed at the center of an electrode assembly that is wound in cylinder shape. Aspect of the present invention further relate to a cylindrical secondary battery including the center pin.

According to an aspect of the present invention, a center pin of a cylindrical secondary battery has a polygonal hole formed along the central axis of the center pin. The polygonal hole has a polygonal cross-section and each corner of the polygonal hole has a curvature.

According to another aspect of the present invention, the cylindrical secondary battery includes: an electrode assembly including a positive electrode plate, a negative electrode plate and a separator disposed between the two plates; a cylindrical center pin disposed at a center of the electrode assembly and having a polygonal hole formed along a center axis of the center pin; a can containing the electrode assembly and the center pin; and a cap assembly sealing the can, wherein the polygonal hole has a polygonal cross-section and each corner of the polygonal hole of the center pin has a curvature.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an assembled perspective view of a cylindrical secondary battery according to an embodiment of the present invention;

FIG. 2 is an exploded perspective view of the cylindrical secondary battery of FIG. 1; and

FIG. 3 is a perspective view of the center pin of the cylindrical secondary battery of FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In the drawings, the thickness of layers and regions may be exaggerated for clarity. Further, when it is stated herein that one part is “connected” to another part, the one part may be directly connected to the other part, or the one part and the other part may be electrically connected at respective sides of another device or conductive element.

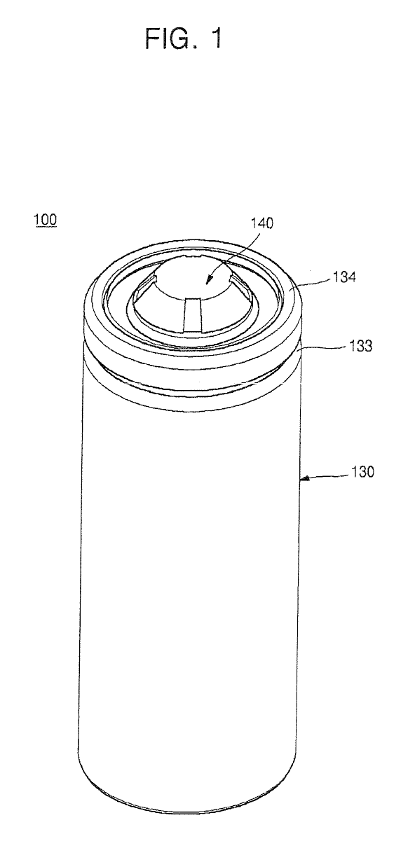

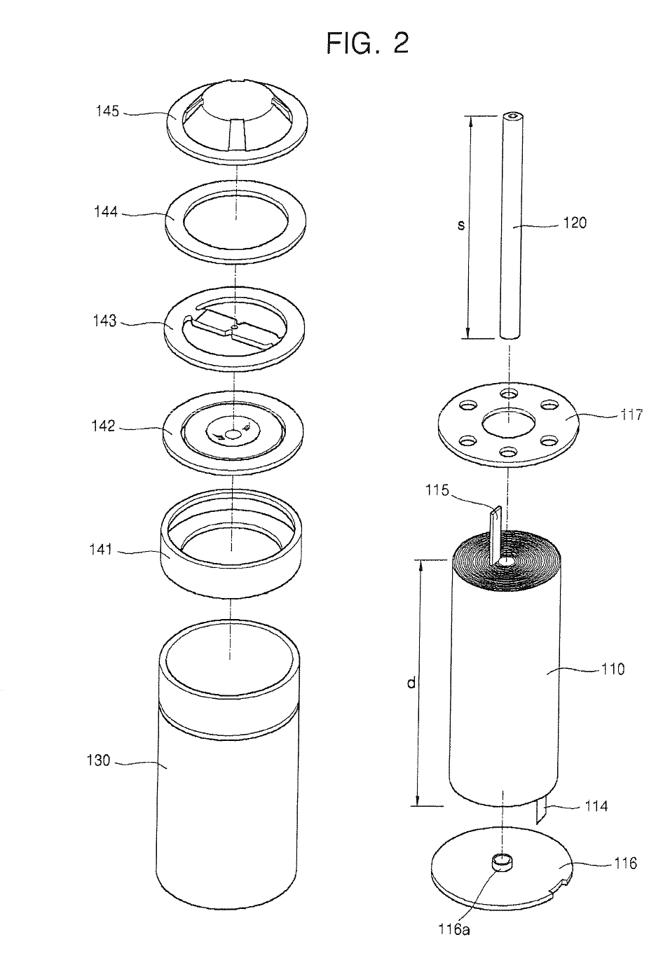

FIG. 1 is an assembled perspective view of a cylindrical secondary battery according to an embodiment of the present invention, and FIG. 2 is an exploded perspective view of the cylindrical secondary battery.

Referring to FIGS. 1 and 2, a cylindrical secondary battery 100 includes an electrode assembly 110 that is wound in cylinder shape, a center pin 120 disposed at a center of the electrode assembly 110, a can 130 containing the electrode assembly 110, center pin 120 and an electrolyte (not illustrated) that enables ions such as, for example, lithium ions, to travel between electrodes of the electrode assembly 110, and a cap assembly 140 sealing the can 130.

The electrode assembly 110 includes a positive electrode plate including a positive electrode collector to which a positive electrode active material (not illustrated) is applied, and a positive electrode tab 115 electrically connected to one side of the positive electrode collector and projecting toward the cap assembly 140; a negative electrode plate including a negative electrode collector 115 to which a negative electrode active material (not illustrated) is applied, and a negative electrode tab 116 electrically connected to one side of the negative electrode collector and projecting in an opposite direction to the positive electrode tab 115; and a separator disposed between the two electrode plates. Although it is described herein that the positive electrode tab 115 of the electrode assembly 110 projects toward the cap assembly 140, it is to be understood that the negative tab 116 of the electrode assembly 110 may project toward the cap assembly 140, and the positive electrode tab 115 may project in an opposite direction to the negative electrode tab 116.

The positive electrode active material may include a lithium-containing transition metal oxide or a lithium chalcogenide compound such as LiCoO₂, LiNiO₂, LiMnO₂, LiMn₂O₄ or LiNi_{1-x-y}COₓM_{y}O₂ (wherein, 0≦x≦1, 0≦y≦1, 0≦x+y≦1, and M is Al, Sr, Mg or La). The negative electrode active material may include a carbon material such as crystalline carbon, amorphous carbon, a carbon complex or a carbon fiber, lithium metal, or a lithium alloy.

The positive electrode collector or the negative electrode collector may be formed of at least one selected from the group consisting of stainless steel, nickel, copper, aluminum and an alloy thereof. For example, the positive electrode collector may be formed of aluminum or an aluminum alloy and the negative electrode collector may be formed of copper or a copper alloy, to provide improved efficiency of the collectors.

The separator disposed between the positive electrode plate and the negative electrode plate prevents an electrical short circuit between the positive electrode plate and the negative electrode plate, and allows lithium ions to travel between the respective electrode plates. The separator may be formed of a polyolefin-based polymer layer such as polyethylene (PE) or polypropylene (PP) or a multi layer thereof.

The electrolyte enables movement of lithium ions generated by an electrochemical reaction between the positive electrode plate and the negative electrode plate of the electrode assembly 110 during charge/discharge operation, and may be a non-aqueous organic electrolyte which is a mixture of a lithium salt and a high-purity organic solvent, or a polymer using a polymer electrolyte.

Although the cylindrical secondary battery 100 is described as a lithium secondary battery, it is to be understood that aspects of the present invention described herein may be applied to any other type of secondary battery having a electrode assembly 110 that is wound in a cylindrical shape and that appropriate materials may be selected for the positive electrode plate, the negative electrode plate, the separator and the electrolyte.

The cap assembly 140 includes a cap-up 145 connected to a top opening of the can 130 to seal the can 130, and connected to an external terminal; a safety vent 142 electrically connected to the positive electrode tab 115 of the electrode assembly 110, and that deforms or breaks down to exhaust a gas when an inner pressure reaches more than a certain level due to a gas generated in the electrode assembly 110; a current interrupt device (CID) 143 disposed on the safety vent 142 and that breaks down or is cut by the safety vent 142 to cut off connection between the electrode assembly and an external terminal, when the safety vent 142 is deformed due to pressure from gas generated in the electrode assembly 110; and a gasket 141 that insulates the cap assembly 140 from the can 130. The cap assembly 140 may further include a circular positive temperature coefficient (PTC) device 144 disposed between the CID 143 and the cap-up 145 to prevent the flow of over-current between the battery assembly 110 and the external terminal.

The can 130 is formed in the shape of a cylinder having a specific radius. The top of the can 130 is open so that the electrode assembly 110 and the electrolyte can be inserted thereinto. The bottom of the can may be closed or may be sealed off by a bottom plate 116 as described below. The can 130 may be formed of a lightweight and flexible metal such as aluminum, an aluminum alloy or stainless steel. The can 130 itself may function as a positive or negative electrode terminal, when the can 130 is electrically connected to the positive electrode tab 115 or the negative electrode tab 116.

After the can 130 is sealed with the cap assembly 140, in order to prevent the separation of the cap assembly 140 from the can 130, a beading part 133 is formed to project a certain distance inwardly from an outer surface of the can 130 corresponding to the bottom of the cap assembly 140, and a crimping part 134 is partially bent inward about the cap assembly 140 over the can 130. The beading part 133 and the crimping part 134 improve the bonding strength between the cap assembly 140 and the can 130 to prevent the outflow of the electrolyte contained in the can 130 and to tightly seal the can 130 to increase an inner pressure during the occurrence of an internal disorder.

In order to prevent an undesirable connection between the electrode assembly 110 and the can 130, the cylindrical secondary battery may further include an upper insulting plate 117 disposed over the electrode assembly 110 and including at least one hole through which a gas generated from the electrode assembly 110 may flow, and a lower insulating plate 116 disposed under the electrode assembly 110. The lower insulating plate 116 may have a cavity 116a into which an end of the center pin 120 is inserted to fix the center pin at the center of the lower insulating plate. That is, when the center pin 120 is inserted into the cavity 116a, the center pin is prevented from shifting laterally and remains centered in the cylindrical secondary battery. The cavity 116a may be formed in a raised region of the lower insulating plate that projects toward the cap assembly 140 to increase a contact area with the center pin 120.

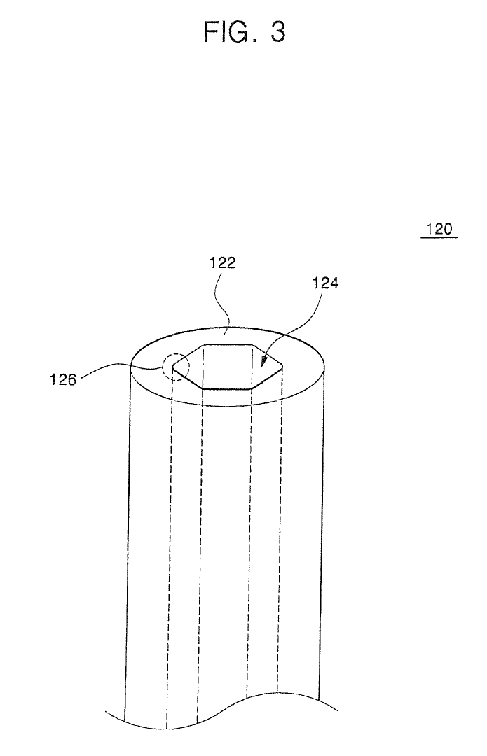

FIG. 3 is a perspective view of the center pin of the cylindrical secondary battery.

As shown in FIG. 2, the center pin 120 of the cylindrical secondary battery 100 is disposed at the center of the cylindrically-wound electrode assembly 110 to prevent the deformation of the electrode assembly 110 during charge/discharge operations of the cylindrical secondary battery 100. As shown in FIG. 3, the center pin has a cylindrical shape with a polygonal hole 124 formed in a longitudinal direction to provide a path through which a gas generated from the electrode assembly 110 flows toward the cap assembly 140 in case of an internal disorder of the cylindrical secondary battery 100. The corners 126 of the polygonal hole 124 are formed to have a curvature so as to provide a greater thickness of the center pin 120 between the corners 126 and the exterior longitudinal surface of the center pin. Although corners 126 of the polygonal hole 124 may be formed to have different curvatures, as a specific non-limiting example, all of the corners 126 of the polygonal hole 124 may have the same curvature such that the polygonal hole 124 is symmetrical. For example, the curvature of the corner 126 may be the same as that of a circumscribed circle of the polygonal hole 124.

Although a cross-section of the polygonal hole 124 formed in the center pin 120 may be formed in the shape of a triangle or square or other polygonal shapes, considering that rotatory power is applied to rotate the center pin 120 through the polygonal hole 124, as a specific, non-limiting example, the polygonal hole 124 may be hexagonal, and the center pin 120 may be formed of a metallic material such as stainless steel (SUS), or an insulating material such as polybutylene terephthalate (PBT).

When a radius of an inscribed circle of the polygonal hole 124 is less than 0.4 times the radius of the center pin 120, sufficient rotatory power cannot be provided through the hole 124 for rotating the center pin 120 during the winding of the electrode assembly 110. On the other hand, when the radius of an inscribed circle of the polygonal hole 124 is more than 0.9 times the radius of the center pin 120, the thickness 122 of the center pin 120 becomes thinner as the area of the polygonal hole 124 increases, and the center pin 120 thus becomes weaker so that deformation of the electrode assembly 110 cannot be sufficiently prevented during charge/discharge operations of the cylindrical secondary battery 100. For this reason, the radius of the inscribed circle of the polygonal hole 124 may be 0.4 to 0.9 times that of the center pin 120.

Moreover, when a length s of the center pin 120 is less than 90% of a thickness d of the electrode assembly 110, it may be difficult for the center pin 120 to fix or support the electrode assembly 110, and thus it may be difficult to prevent the deformation of the electrode assembly 110. When the length s is greater than 110% of the thickness d of the electrode assembly 110, the center pin 120 may contact a component of the cap assembly 140 disposed on the electrode assembly 110, so that the undesirable deformation or break-down of the safety vent may occur. Therefore, the length s of the center pin 120 may be 90 to 110% of the thickness d of the electrode assembly 110.

Table 1 shows the degree of deformation to an inner diameter of the center pin, and compares the degree of deformation of the electrode assembly during charge/discharge operations of a cylindrical secondary battery having a center pin in which a polygonal hole with a rounded corner is formed and a cylindrical secondary battery having a center pin in which a polygonal hole with a sharp corner is formed, based on a material of the center pin.

TABLE 1

| Shape of Corner | SUS | PBT |
|---|---|---|
| sharp | 0.681% | 5.532% |
| rounded | 0.673% | 5.475% |

As can be seen from Table 1, when the polygonal hole, which is formed in the center pin in a longitudinal direction, has a rounded corner, the electrode assembly is less deformed than when the polygonal hole has a sharp corner. As shown, the actual results depend on the material of the center pin. Having rounded corners for the polygonal hole reinforces the strength of the center pin, and when the center pin is formed of PBT, which has less strength than SUS, the gain in strength of the center pin when the polygonal hole has rounded corners is greatly enhanced.

As a result, in the cylindrical secondary battery according to the embodiment of the present invention, when a corner of the polygonal hole formed in the center pin in a longitudinal direction has a curvature, the strength of the center pin may be reinforced, and thus the deformation of the electrode assembly may be reduced during charge/discharge operations of the cylindrical secondary battery.

Consequently, a center pin of a cylindrical secondary battery has a polygonal hole formed in a longitudinal direction, and each corner of the hole has a curvature, so that deformation of an electrode assembly can be minimized during charge/discharge operations of the cylindrical secondary battery.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A center pin of a cylindrical secondary battery,
wherein the center pin is cylindrically shaped,
wherein a polygonal hole extends along a central axis of the center pin, the polygonal hole having a polygonal shape in a cross-section perpendicular to the central axis of the center pin, and
wherein each corner of the polygonal hole has a curvature.

2. The center pin according to claim 1, wherein the curvatures of the corners of the polygonal hole are equal.

3. The center pin according to claim 2, wherein the curvature of each corner is the same as the curvature of a circumscribed circle of the polygonal hole.

4. The center pin according to claim 1, wherein a radius of an inscribed circle of the polygonal hole is 0.4 to 0.9 times a radius of the center pin.

5. The center pin according to claim 1, wherein a cross-section of the polygonal hole is hexagonal.

6. The center pin according to claim 1, wherein the center pin is formed of polybutylene terephthalate or stainless steel.

7. The center pin according to claim 1, wherein the corners of the polygonal hole have different curvatures from one another.

8. A cylindrical secondary battery, comprising:
an electrode assembly including a positive electrode plate, a negative electrode plate and a separator disposed between the two electrode plates;
a center pin disposed at a center of the electrode assembly and having a cylindrical shape with a polygonal hole extending along a central axis of the center pin, the polygonal hole having a polygonal shape in a cross-section perpendicular to the central axis of the center pin;
a can containing the electrode assembly and the center pin; and
a cap assembly sealing the can,
wherein each corner of the polygonal hole of the center pin has a curvature.

9. The battery according to claim 8, wherein the corners of the polygonal hole have the same curvature.

10. The battery according to claim 9, wherein the curvature of each corner of the polygonal hole is the same as that of a circumscribed circle of the polygonal hole.

11. The battery according to claim 8, wherein a radius of an inscribed circle of the polygonal hole is 0.4 to 0.9 times a radius of the center pin.

12. The battery according to claim 8, wherein a length of the center pin is 90% to 110% of a thickness of the electrode assembly.

13. The battery according to claim 8, wherein the corners of the polygonal hole have different curvatures from one anther.

14. The battery according to claim 8, wherein the center pin is formed of polybutylene terephthalate or stainless steel.

15. The battery according to claim 8, further comprising:
a lower insulating plate disposed under the electrode assembly.

16. The battery according to claim 15, wherein the lower insulating plate comprises a cavity that fixes the center pin.

17. The battery according to claim 16, wherein the cavity that fixes the center pin is formed in a raised region of the lower insulating plate that projects toward the cap assembly.

18. The battery according to claim 8, wherein one side of the electrode assembly is fixed to the center pin.

19. The battery according to claim 18, wherein the electrode assembly is wound into a cylindrical shape by rotating the center pin.

20. The battery according to claim 8, wherein a cross-section of the polygonal hole is hexagonal.
